(19) United States
(12) Patent Application Publication
(10) Pub. No.: US 2018/0332989 A1
(43) Pub. Date: Nov. 22, 2018

(54) WATER INTAKE CALCULATING DEVICE AND SYSTEM

(71) Applicant: HON HAI PRECISION INDUSTRY CO., LTD., New Taipei (TW)

(72) Inventors: HSIAO-PING CHIU, New Taipei (TW); YU-TEH LU, New Taipei (TW); JUNG-CHENG LIU, New Taipei (TW)

(21) Appl. No.: 15/653,687

(22) Filed: Jul. 19, 2017

(30) Foreign Application Priority Data
May 18, 2017 (TW) 106116498

(51) Int. Cl. A47G 23/10; G01G 23/37; G01G 21/22

(52) U.S. Cl. CPC A47G 23/10; G01G 23/3728; G01G 21/22; G01G 23/3721

(57) ABSTRACT

A device for measuring fluid includes a casing, and a weight sensing unit, a microprocessor, and a wireless communication unit. The weight sensing unit generates a weight signal corresponding to a weight of a cup and contents cup and contents rested on the casing. The microprocessor generates a control signal as to weight of the cup and contents each time the microprocessor receives the weight signal from the weight sensing unit. The microprocessor transmits the control signal to an electronic device wirelessly, commanding the electronic device to calculate current and cumulative water cup and contents each time the electronic device receives the control signal. The calculated water intake includes a current water intake and a cumulative water intake displayable for the information of the user.

### FIELD

The subject matter herein generally relates to health and a water intake calculating device that monitors information of water intake of a user.

### BACKGROUND

Most people do not drink enough water and can be in a slightly dehydrated state, and thus uncomfortable. Presently, most water intake calculating device available in the market can determine whether or not sufficient water is taken by the users. However, existing water intake calculating devices are inconvenient to use and are not precise enough for the calculation of the amount of, e.g., water being taken.

### BRIEF DESCRIPTION OF THE DRAWINGS

Implementations of the present technology will now be described, by way of example only, with reference to the attached figures.

FIG. 1 is a diagrammatic view of an exemplary embodiment of a water intake calculating device.

FIG. 2 is a block diagram of a water intake calculating system comprising the water intake calculating device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

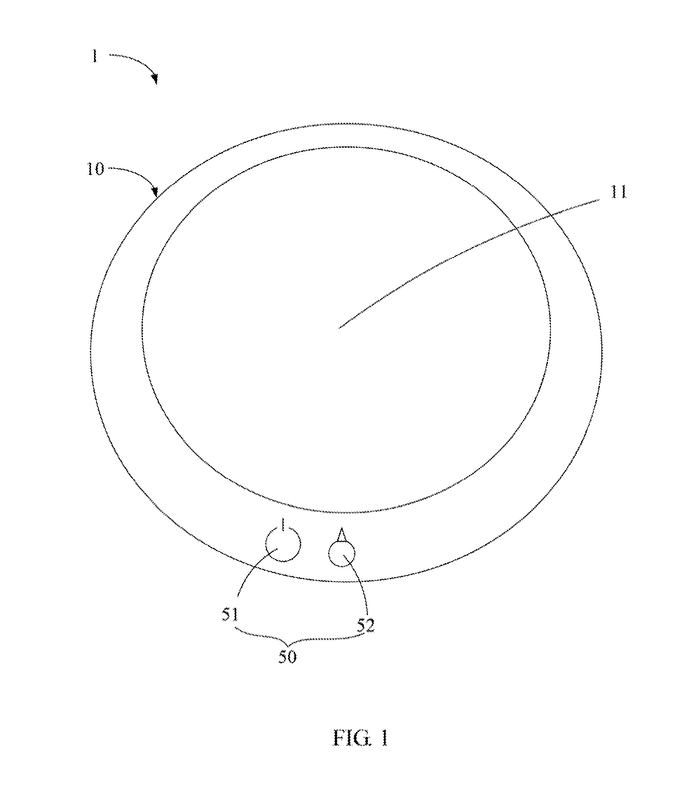

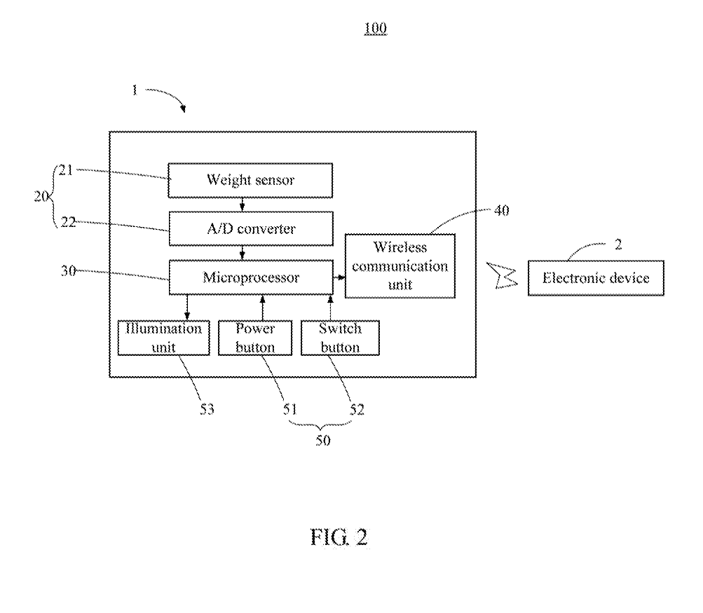

FIGS. 1 and 2 illustrate an exemplary embodiment of a water intake calculating system 1. The water intake calculating system 100 comprises a water intake calculating device 1 and an electronic device 2 which can wirelessly communicate with the water intake calculating device 1. In the exemplary embodiment, the water intake calculating device 1 can be an intelligent electronic coaster. The electronic device 2 can be a smart phone.

The water intake calculating device 1 comprises a casing 10, a weight sensing unit 20, a microprocessor 30, a wireless communication unit 40, and a button area 50. The weight sensing unit 20, the microprocessor 30, and the wireless communication unit 40 are received in the casing 10. The button area 50 is positioned on an outer surface of the casing 10.

In at least one exemplary embodiment, the casing 10 comprises a scale pan 11 which is positioned in a central outer portion of the casing 10. The scale pan 11 comprises a flat surface for supporting and weighing a cup and contents resting thereon.

The weight sensing unit 20 generates a digital weight signal corresponding to the weight of the cup and contents each time the cup and contents are rested on the scale pan 11.

In at least one exemplary embodiment, the weight sensing unit 20 comprises a weight sensor 21 and an analog-to-digital (A/D) converter 22. The weight sensor 21 generates an analog voltage signal corresponding to the weight of the cup and contents each time the cup and contents are rested on the scale pan 11. The weight sensing unit 20 can use a Wheastone Circuit to generate the analog voltage signal. The A/D converter 22 converts the analog voltage signal to the digital weight signal.

The microprocessor 30 generates a control signal comprising the weight of the cup and contents each time the microprocessor 30 receives the digital weight signal from the weight sensing unit 20. The microprocessor 30 can be a central processing unit (CPU), a microprocessor, or other suitable data processor chip that performs various functions of the water intake calculating device 1.

The button area 50 comprises a power button 51. The power button 51 provides a power on or power off signal when the power button 51 is clicked, and generates a connection establishing signal when the power button 51 is pressed for a period. The power button 51 can be a mechanical button or a virtual icon.

The microprocessor 30 further powers on or powers off the water intake calculating device 1 when the microprocessor 30 receives the power on or power off signal. The microprocessor 30 further causes the wireless communication unit 40 to search for other electronic devices within a preset range when the microprocessor 30 receives the connection establishing signal. When the wireless communication unit 40 finds at least one electronic device 2, the microprocessor 30 causes the wireless communication unit 40 to establish a wireless connection between the water intake calculating device 1 and the electronic device 2. In at least one exemplary embodiment, the wireless communication unit 40 is a short-distance communication device such as a BLUETOOTH™ unit.

The microprocessor 30 further transmits the control signal to the electronic device 2 when the water intake calculating device 1 and the electronic device 2 establish the wireless connection, thereby causing the electronic device 2 to calculate the water intake according to the weight of the cup and contents each time the electronic device 2 receives the control signal. The calculated water intake can comprise a current water intake and a cumulative water intake.

That is, when a user wants to enable the water intake calculating device 1, the user can first click the power button 51, and press the power button 51 for a period to control the water intake calculating device 1 and the electronic device 2 to establish a wireless connection, thereby commanding the electronic device 2 to begin determining a water intake according to the changes in the weight of the cup and contents measured by the water intake calculating device 1, as described below.

In at least one exemplary embodiment, the water intake calculating device 1 further comprises an illumination unit 53 positioned under the power button 51. The microprocessor 30 further causes the illumination unit 53 to emit light when the microprocessor 30 receives the power on signal, thereby providing a visual feedback to the user. At least one portion of the power button 51 is transparent to allow the light to pass through.

The microprocessor 30 further transmits the control signal to the electronic device 2 when the water intake calculating device 1 and the electronic device 2 establish the wireless connection, thereby telling the electronic device 2 to calculate the water intake according to the weight of the cup and contents each time the electronic device 2 receives the control signal.

For example, when the user places a cup and contents on the water intake calculating device 1 for the first time, the weight measuring unit 20 outputs a digital weight signal corresponding to the current total weight (denoted as “D₁”) of the cup and contents. The current water intake C₁ is initialized as zero, and the cumulative water intake S₁ is initialized as zero.

The total weight of the cup and contents equals the weight of the cup plus the weight of the water in the cup. The current water intake equals the previous total weight of the cup and contents minus the current total weight of the cup and contents. When the user places the cup and contents on the water intake calculating device 1 for the second time, the weight measuring unit 20 outputs a digital weight signal corresponding to the current total weight (denoted as “D₂”) of the cup and contents. Thus, the current water intake C₂ can be calculated as: C₂=D₁−D₂. The cumulative water intake equals the previous cumulative water intake plus the current water intake. Thus, the cumulative water intake S₂ can be calculated as: S₂=C₁+C₂=S₁+C₂=D₁−D₂. When the user places the cup and contents on the water intake calculating device 1 for the third time, the weight measuring unit 20 outputs a digital weight signal corresponding to the current total weight (denoted as “D₃”) of the cup and contents. Thus, the current water intake C₃ can be calculated as: C₃=D₂−D₃. The cumulative water intake S₃ can be calculated as: S₃=C₁+C₂+C₃=S₂+C₃=D₁−D₂+D₂−D₃=D₁−D₃. Because the density p of water may approximate to 1.0, each of the current water intake and the cumulative water intake S₁ divided by the gravitational acceleration can be determined as the volume of water intake. That is, the electronic device 2 can calculate the volume of current water intake and the volume of cumulative water intake.

In at least one exemplary embodiment, the electronic device 2 can further comprise an output unit (not shown) for outputting the current water intake and the cumulative water intake for the information of the user. The output unit can be a loudspeaker or a display screen apart from any similar output devices associated with the electronic device 2.

In at least one exemplary embodiment, the button area 50 further comprises a switch button 52. The switch button 52 generates a switch signal when the switch button 52 is pressed. The microprocessor 30 can further switch the water intake calculating device 1 to another mode, for example, a mode for measuring the weight of particular food (for example, fruit or rice). At this time, the water intake calculating device 1 functions as a common weighing device which allows the user to notice the amount of food being eat and estimate the intake of calories accordingly.

With the above configuration, the water intake calculating system 100 can calculate the current water intake and the cumulative water intake each time the user places the cup and contents on the water intake calculating device 1. Thus, the water intake calculating device 1 is convenient to use, and is precise for the calculation of the water intake.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. A water intake calculating device comprising:
a weight sensing unit including a scale pan, the weight sensing unit configured to generate a digital weight signal corresponding to a weight of a cup and contents each time the cup and contents are rested on the scale pan;
a microprocessor, the microprocessor configured to generate a control signal comprising the weight of the cup and contents each time the microprocessor receives the digital weight signal from the weight sensing unit; and
a wireless communication unit;
wherein the microprocessor further transmits the control signal to an electronic device when the water intake calculating device and the electronic device establish a wireless connection, thereby telling the electronic device to calculate a water intake according to the weight of the cup and contents each time the electronic device receives the control signal, the calculated water intake comprises at least one of a current water intake and a cumulative water intake.

2. The water intake calculating device of claim 1, further comprising a casing, the scale pan positioned in a central portion of the casing for supporting the cup and contents.

3. The water intake calculating device of claim 1, wherein the weight sensing unit comprises a weight sensor and an A/D converter, the weight sensor generates an analog voltage signal corresponding to the weight of the cup and contents each time the cup and contents are rested on the scale pan, and the A/D converter converts the analog voltage signal to the digital weight signal.

4. The water intake calculating device of claim 1, further comprising a button area positioned on an outer surface of the casing, wherein the button area comprises a power button, the power button generates a power on or power off signal when the power button is clicked, and the microprocessor further powers on or powers off the water intake calculating device when the microprocessor receives the power on or power off signal.

5. The water intake calculating device of claim 4, wherein the power button further generates a connection establishing signal when the power button is pressed for a period, the microprocessor further causes the wireless communication unit to search for other electronic devices within a preset range when the microprocessor receives the connection establishing signal, when the wireless communication unit finds the electronic device, the microprocessor causes the wireless communication unit to establish a wireless connection between the water intake calculating device and the electronic device.

6. The water intake calculating device of claim 5, wherein the wireless communication unit is a short-distance communication device.

7. The water intake calculating device of claim 4, further comprising an illumination unit positioned under the power button, wherein the microprocessor further causes the illumination unit to emit light when the microprocessor receives the power on signal.

8. The water intake calculating device of claim 4, wherein the button area further comprises a switch button, the switch button generates a switch signal when the switch button is pressed, and the microprocessor further switches the water intake calculating device to a mode for measure a weight of food.

9. A water intake calculating system comprising:
a water intake calculating system comprising:
a weight sensing unit including a scale pan, the weight sensing unit configured to generate a digital weight signal corresponding to a weight of a cup and contents each time the cup and contents are rested on the scale pan;
a microprocessor, the microprocessor configured to generate a control signal comprising the weight of the cup and contents each time the microprocessor receives the digital weight signal from the weight sensing unit; and
a wireless communication unit; and
an electronic device;
wherein the microprocessor further transmits the control signal to an electronic device when the water intake calculating device and the electronic device establish a wireless connection, the electronic device is configured to calculate a water intake according to the weight of the cup and contents each time the electronic device receives the control signal, the calculated water intake comprises at least one of a current water intake and a cumulative water intake.

10. The water intake calculating system of claim 9, wherein the water intake calculating device further comprises a casing, the scale pan positioned in a central portion of the casing for supporting the cup and contents.

11. The water intake calculating system of claim 9, wherein the weight sensing unit comprises a weight sensor and an A/D converter, the weight sensor generates an analog voltage signal corresponding to the weight of the cup and contents each time the cup and contents are rested on the scale pan, and the A/D converter converts the analog voltage signal to the digital weight signal.

12. The water intake calculating system of claim 9, wherein the water intake calculating device further comprises a button area positioned on an outer surface of the casing, the button area comprises a power button, the power button generates a power on or power off signal when the power button is clicked, and the microprocessor further powers on or powers off the water intake calculating device when the microprocessor receives the power on or power off signal.

13. The water intake calculating system of claim 12, wherein the power button further generates a connection establishing signal when the power button is pressed for a period, the microprocessor further causes the wireless communication unit to search for other electronic devices within a preset range when the microprocessor receives the connection establishing signal, when the wireless communication unit finds the electronic device, the microprocessor causes the wireless communication unit to establish a wireless connection between the water intake calculating device and the electronic device.

14. The water intake calculating system of claim 13, wherein the wireless communication unit is a short-distance communication device.

15. The water intake calculating system of claim 12, wherein the water intake calculating device further comprises an illumination unit positioned under the power button, the microprocessor further causes the illumination unit to emit light when the microprocessor receives the power on signal.

16. The water intake calculating system of claim 12, wherein the button area further comprises a switch button, the switch button generates a switch signal when the switch button is pressed, and the microprocessor further switches the water intake calculating device to a mode for measure a weight of food.
